(19) United States
(12) Patent Application Publication
(10) Pub. No.: US 2010/0121563 A1
(43) Pub. Date: May 13, 2010

(54) REAL-TIME PERSONAL DEVICE TRANSIT INFORMATION PRESENTMENT

(75) Inventors: Salvador E. Chavez, Piscataway, NJ (US); David J. Delia, Lagrangeville, NY (US); Wayne M. Delia, Poughkeepsie, NY (US); Paul M. Musumarra, Cary, NC (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/266,636

(22) Filed: Nov. 7, 2008

(51) Int. Cl. G01C 21/00

(52) U.S. Cl. 701/201

(57) ABSTRACT

Methods, including service methods, articles of manufacture, systems, articles and programmable devices provide personalized, real-time travel information to a passenger of a transit system. A passenger provides a destination input to a programmable personal digital assistant, which establishes wireless communication with a wireless broadcast system of a transit system and uploads current routing and scheduling information, processing and presenting information to the passenger as a function of destination and passenger preference. The personal digital assistant also selects and wirelessly locates and communicates directly with the identified transport, alerts the passenger of a recommended boarding opportunity, recognizes a boarding by the passenger, confirms that a boarded transport is the recommended transport, and communicates a disembark alert to if the boarded transport is not the recommended transport or upon an arrival at a destination, the alert configured pursuant to the passenger preference.

### FIELD OF THE INVENTION

The present invention generally describes methods, systems and devices for providing real-time, personal travel information and alerts with respect to a mass transit system.

### BACKGROUND OF THE INVENTION

A wide variety of users with different and sometimes divergent or mutually exclusive communications needs may utilize a given public mass transit system, which may utilize a variety of passenger transport vehicles and apparatuses (for example buses, trains, ferries, etc.). Although a mass transit system may provide routing, scheduling, fare and other use information through a variety of media in a variety of languages and formats, problems still arise in meeting the needs of individual passengers in facilitating their use of the various transports, stations and other access points, schedules, routing and other components of a given mass transit system.

For example, with respect to access points that provide boarding and disembarking opportunities for multiple individual and distinct transport routes, passengers may have difficulty in correctly identifying and selecting a correct transport for their destination. Additionally, once a transport has been selected and boarded, if the transport serves a plurality of stops or destinations it is common for passengers to rely on public audio announcements from a speaker system on the transport to identify their current position in relation to their destination, as well as their target stop for disembarking to reach their destination, which may include a transfer point to still another transport. Passengers unfamiliar with all or part of the route, and further those who may have trouble understanding audio and other media information utilized to convey location and destination information (e.g. tourists and foreign visitors unfamiliar with the generally geography of a given transit system or the languages used for announcements and audio information, or passengers with audio or visual impairment relative to information systems) may have difficulties in using the mass transit system, in some cases resulting in boarding the wrong transport or missing a transfer point or other disembarkation point.

### SUMMARY OF THE INVENTION

Personalized, real-time travel information is provided to a passenger of a transit system. A passenger provides a destination input to a programmable personal digital assistant carried by the passenger. The personal digital assistant establishes a wireless communication with a wireless broadcast system of a transit system and uploads current routing and scheduling information relative to a present geographic location through the wireless communication in response to the destination input, and further processes uploaded routing and scheduling information and presents the processed information to the passenger as a function of the destination input and a passenger preference. The personal digital assistant also selects and wirelessly locates a transport of the transit system in real-time in response to the destination input by communicating directly with the identified transport through a wireless communication, and also alerts the passenger of a recommended boarding opportunity of the identified transport in response to locating the transport relative to a location of the passenger. The personal digital assistant also recognizes a boarding by the passenger of a transport through spatially locating the personal digital assistant within the boarded transport via a wireless communication with the boarded transport, confirms that the boarded transport is the identified and recommended transport. Additionally, the personal digital assistant also communicates a disembark alert to the passenger in response to determining that the boarded transport is not the identified recommended transport and that a change in transport is necessary to reach the destination, and to determining an arrival at the destination by the boarded transport, wherein the disembark alert is configured and presented to the passenger as a function of the passenger preference.

Service methods are also provided comprising deploying applications for providing personalized real-time travel information to a passenger of a transit system according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for providing personalized real-time travel information to a passenger of a transit system. Moreover, systems, articles and programmable devices are also provided, configured for performing one or more method and/or process elements of the current invention for providing personalized real-time travel information to a passenger of a transit system, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a flow chart illustrating a method and system for providing personalized real-time travel information to a passenger of a transit system according to the present invention.

FIG. 2 is diagrammatic illustration of an implementation of a method and system for providing personalized real-time travel information to a passenger of a transit system according to the present invention.

FIG. 3 is a block diagram of a system or device configured to provide personalized real-time travel information to a passenger of a transit system according to the present invention.

FIG. 4 is a block diagram illustrating a computerized implementation of a method and system for providing personalized real-time travel information to a passenger of a transit system according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience the Detailed Description of the Invention has the following sections:

I. General Description; and

II. Computerized Implementation.

### I. General Description

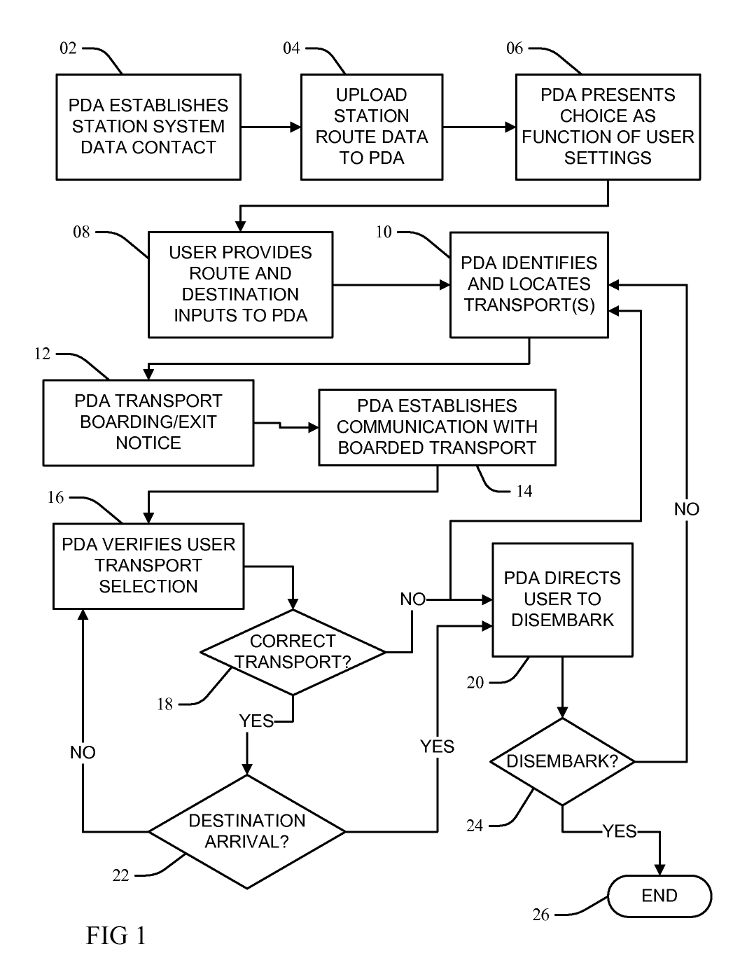

The present application discloses systems, methods, devices and program products for providing personalized real-time travel information to a passenger of a transit system. FIG. 1 illustrates one embodiment of the present invention wherein at 02 a programmable personal digital assistant (PDA) carried by a passenger establishes a wireless communication with a wireless broadcast system of a transit system, for example in response to a passenger carrying the PDA entering a transit system station or stop area or area proximate thereto. At 04 the PDA uploads current routing and scheduling information relative to the station from the wireless broadcast system through the wireless communication. In some embodiments the information is specific to the station or stop, for example selecting only route and scheduling relative to transports that offer possible service to the station or meet a passenger preference (e.g. wheelchair lift service for a passenger providing a wheelchair service preference, or bicycle rack available for a passenger on a bicycle), while other embodiments or preference settings may cause retrieval of more complete or general transit system information.

The PDA may also use scheduling and routing information previously uploaded, rather than automatically uploading current routing and scheduling information each time a station or stop is approached or entered. A transit system may revise schedules infrequently, thus in some embodiments the PDA may be configured to use previously uploaded data after confirmation through communication with the station wireless broadcast system that the already-uploaded data is still current, uploading new data when a revision is determined by the PDA or where notice of a new revision is to the PDA through the wireless communication.

At 06 the PDA processes the uploaded routing and scheduling information as a function of a personal passenger preference and presents the processed routing and schedule information to the passenger accordingly (e.g. in a graphical user interface (GUI) or through audio prompts). A user-provided preference, or setting specified by a service provider, may configure the PDA to present information to the passenger in a specific language, or to produce an audio presentation of uploaded written schedules and routes, as is more fully discussed below. The passenger reviews the information presented by the PDA and enters a destination input at 08 for use by the PDA to provide routing and other transport use information according to the present invention.

Accordingly, at 10 the PDA uses the passenger input to identify and locate an appropriate transit system transport that will serve the needs of the passenger in achieving travel toward the destination input, optionally also meeting one or more preferences specified by the passenger or a service provider, and notifies the passenger at 12 of an opportunity for boarding a transport so identified (e.g. through an audio prompt through PDA headphones stating “Board E-line train in five minutes at platform B”). More particularly, the PDA wirelessly locates the selected and identified transport in real-time in response to the destination input by communicating directly with the identified transport through a wireless communication, in some embodiments independent of any centralized transit system computer or communication system.

According to the present invention the PDA also recognizes a boarding by the passenger of a transport at the station through spatially locating the personal digital assistant within the boarded transport by communicating directly with the boarded transport at 14 through wireless communication, and further uses this communication and recognition to confirm or otherwise verify at 16 that the passenger has boarded the correct transport as identified and recommended to the passenger at 12 above. If it is determined at 18 that the wrong transport has been boarded, then at 20 the PDA configures and presents an appropriate disembark alert to the passenger at 20 if a change in transport is necessary to reach the destination (e.g. “You have entered the wrong train, disembark at the Jamaica street station and return to the Forrest Hills station on the next eastbound E-line train”), in some instances recalculating a new routing and destination solution at 10 above.

If the correct transport boarding is instead confirmed at 18, then the process continues to loop through the correct transport verification at 22 (and at 16, etc.) until an arrival at the destination is determined wherein the PDA configures and presents a disembark alert or other communication to the passenger at 20 as a function of a passenger preference. If the PDA determines at 24 that the passenger failed to disembark at the stop or other point recommended at 20 (e.g. through continued communication with the boarded transport, and in some embodiments through direct communication with a global positioning system (GPS)), then the PDA returns again to recalculating a new routing and destination solution at 10 above and subsequently instructs the passenger accordingly as provided above. If instead it is determined at 24 that the passenger has disembarked at the stop or other point recommended at 20, then the process ends at 26.

It will be appreciated that public mass transportation comprehends a variety of transport and travel options (e.g. bus, train, ferry, pedestrian toll bridge access, canals, bridges, ferries, parking garage, etc.). Moreover, the “transport” encompasses buses and trains as well as public and private automobiles, boats or any other apparatus configured to carry passengers from one destination to another. Passengers and/or their associated transports may travel along dedicated transit infrastructures (e.g. railroad tracks), as well as along defined travel options through their regular paths and schedules (e.g. defining a shipping channel or inter-coastal waterway, in some examples with infrastructure or maintenance supported by fees). Additionally, transport options also comprehend self-powered modes of travel (e.g. bicycle, wheelchair, etc.), over associated infrastructure with or without any vehicle or apparatus (e.g. by foot as a pedestrian over a toll bridge, or onto a ferry, etc.). Thus PDA destination route calculations and instructions according to the present invention may comprehend all of the above examples, as well as others appreciated and known to one skilled in the art.

Prior art methods and systems for guiding passengers in the use of public transit system transports generally require the use and dissemination of general information through centralized, common information systems: for example, speaker announcements over train loudspeakers, or information broadcast through broadcast and web media, each of which may require prerequisite knowledge of the transit system, region or languages used in order to comprehend and utilize. Passengers with specialized needs (e.g. users or foreign languages not supported by such central systems, or those with visual or auditory impairments) they must generally seek out and find appropriate information in prior art systems, sometimes requiring significant efforts in order to successfully engage in use of the transit system with.

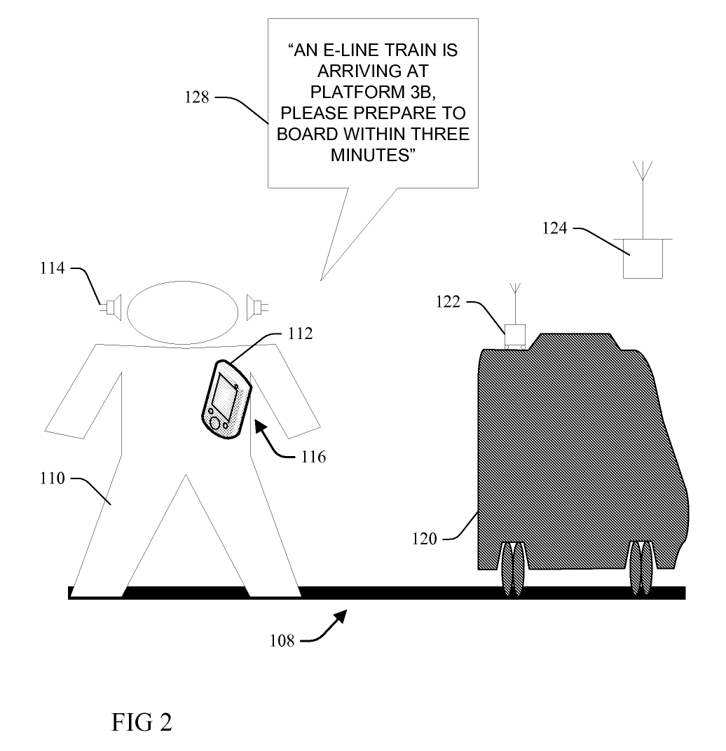

In contrast, the present invention provides for programmable PDA's configured to use wireless communication technology to easily, quickly and effectively achieve a direct link with one or more transports of a public transit system, and optionally with station, stop or more generalized components of a central system, in order to use data there from to guide a passenger through a successful use and navigation of the transit system. FIG. 2 provides one example wherein a programmable PDA 112 carried by a potential passenger 110 is configured to meet the personal needs of the passenger 110 in establishing a direct communication with the wireless node 122 of an individual transit system transport 120 (e.g., bus, train, ferry, lorry, etc), and optionally also with a central transit system wireless access node 124. In one aspect the present invention avoids problems in service interruption and responsiveness caused by interrupted connections to the central transit system wireless access node 124 while accessing location or scheduling data, for example through wireless internet service provider (ISP) and cellular communication breaks caused by movement through weak or no-signal signal areas (e.g. within some subway tunnel areas). Avoiding reliance upon central transit or communication systems also prevents loss of service when a central system goes down or otherwise experiences a service interruption, and instead according to the present invention desired processes may be performed entirely by the passenger's personal PDA 112.

The present invention is also distinguished from prior art methods which require sending personal information to the centralized system node 124 in order to receive requested transit system information. For example, prior art systems may require a passenger to provide email or residence addresses, or telephone or cellular phone numbers, in order to receive transit information, and further may require the provision of additional information in order to create a user account or identification for access to transit system information. In contrast, privacy and personal data security is enhanced in the present invention by enabling a passenger's personal PDA 112 to perform processes and methods without providing personal identification data to a public transit system, ISP, cellular phone carrier or other third-party system. Processed data may be managed and stored or otherwise retained directly and securely upon the PDA 112 itself, which further enables easy and permanent deletion of sensitive data at the discretion of the passenger. No centralized repository of passenger data is required to practice the present invention, at most only the provision of a PDA 112 device identification indicia (ID) may be required for establishing a handshake or other wireless communication protocol with the transport 120 node 122, and then only for the period of time that the passenger is riding or potentially engaging the particular transport 120. Moreover, in some embodiments the PDA 112 is configured to auto-delete transport, location and identification data associated with use of the transport 120 immediately upon disembarking from the transport 120, thus providing additional protection against the divulgation of sensitive personal passenger data through loss of the PDA 112 or through unauthorized access to said data.

In some embodiments, upon arrival to a station or bus stop 108 the passenger 110 may enter a destination into a GUI or audio input interface on his or her mobile PDA 112 configured according to the present invention, the PDA 112 in turn responsively connecting to a wireless data network provided by the transport 120 through its node 122, or by the public transit system through a station or stop node 124. The passenger 110 may program the PDA 112 to perform a variety of specific tasks, for example requesting a one or more audio or visual alerts 128 through either or both of an audio speaker 114 (e.g. a pair of wireless headphones 114) and a visual display 116, including the alert message 128 illustrated in FIG. 2. A wide variety of alerts 128 may be configured and provided, with illustrative but not exhaustive examples including providing an alert when a desired transport arrives at the station or bus stop; providing confirmation upon boarding a transport that it is the right one for a passenger's intended destination, and providing an alert a pre-specified time in advance of arriving at the intended destination or other waypoint, thus giving notice sufficiently in advance or arrival at the destination or waypoint to allow the passenger to prepare for disembarking or boarding the transport.

A PDA 112 appropriate for practicing the present invention will be understood to comprehend a wide variety of programmable devices, including cellular telephone devices and portable music players, and wireless communications may be achieved through Wireless Fidelity (Wifi), Bluetooth® and other wireless receiver and transmitter technology. (BLUETOOTH is a trademark of Bluetooth SIG in the United States or other countries.) More particularly, a software application running on a passenger's PDA 112 equipped with a Wifi, Bluetooth® or other wireless transmitter/receiver component may be given access to a network provided by a public mass transportation system node 124 when a passenger arrives at a station, stop or other connectivity point 108 (e.g. an information kiosk in an airport terminal, etc.), the PDA 112 application downloading specific details about routes or other information available at (e.g. routes specific to the location station or stop 108 wherein the PDA 112 has established connectivity). Utilizing the application, or another application residing on the PDA 112, the PDA 112 may then present the passenger with available route information, for example through a GUI on the device display 116. The passenger can then enter the detail about a desired trip into the PDA 112, for example selecting a specific transport 120 and/or a destination served thereby.

In some embodiments, a transport 120 arriving at the station or stop 108 broadcasts unique identifier data through its node 122 (e.g. a route number, a bus number, a scheduled arrival time or departure time for the present stop or station, etc.) this unique identifier data picked up by the passenger's PDA 112 through a wireless communication connection therewith. If the unique identifier data matches a selection of the passenger 110 or a desired transport 120 as determined by a PDA 112 application then the PDA 112 configures and provides the alert 128 to the passenger (e.g. “An E-train is arriving at platform 3B, please prepare to board within three minutes.”).

Upon boarding the transport 120, in some embodiments a passenger's PDA 112 configured according to the present invention requests access to an information system provided by the transport node 122. The linked transport system then exchanges information with the PDA 112, enabling the PDA 112 to use the transport-provided information to confirm that the passenger is on the correct transport 120, and may also be utilized to estimate a time of arrival at a destination or transfer or other disembarkation point, as well as any special alerts or news provided by another component of a transit system, for example with respect to detours or station closures (e.g. providing another alert 128 stating “The E-line is experiencing construction delays between Jamaica and Forest Hills, scheduled arrival times have been increased by five minutes.”) Information may be continually provided and updated to the PDA 112 by the transport node 122, including current boarded transport 120 (or other connecting transport 120) location data, which may also enable a PDA 112 application to directly calculate revised arrival times and suggested detours or alternative routes and transport options through new alerts 128, for example including recommending a new disembarkation stop or transfer 108, further to a different, non-transit system travel option such as a taxi cab or use of a pedestrian walkway.

Alerts and other PDA 112 communications 128 may be configured pursuant to one or more passenger preference inputs. Thus, a foreign passenger may configure the PDA 112 to translate data and alerts 128 from a first language or jargon into a second language or jargon other not supported by the transport, for example into his or her native language, or to use a jargon or conventional term of preference (e.g. to use “lorry” instead of “bus” for a bus transport option). A hearing-impaired person may configure the PDA 112 to receive data from the transport and system nodes 122/124 comprising audio announcement information and convert the information into a text or other visual format alert 128. Similarly, a visually-impaired person may configured the PDA 112 to receive textual and other visual information (e.g. signs at station, stops or electronic stop display signs on the transport itself) from the transport and system nodes 122/124 and convert the information into an audio alert or communication 128 to the passenger 110. Passengers 110 may also specify alert time frames (e.g. provide an alert 128 one, two or five minutes prior to a destination arrival), or to provide notices 128 to waypoint items of interest to the passenger, for example an alert of an upcoming stop or transfer point 108 for side-trip or diversion from the present destination to a museum or sports facility indicated of interest by a preference input from the passenger, or as provide by a service provider (e.g. a subscriber to a restaurant rating service may be notified of an opportunity 108 to disembark near a highly rated restaurant).

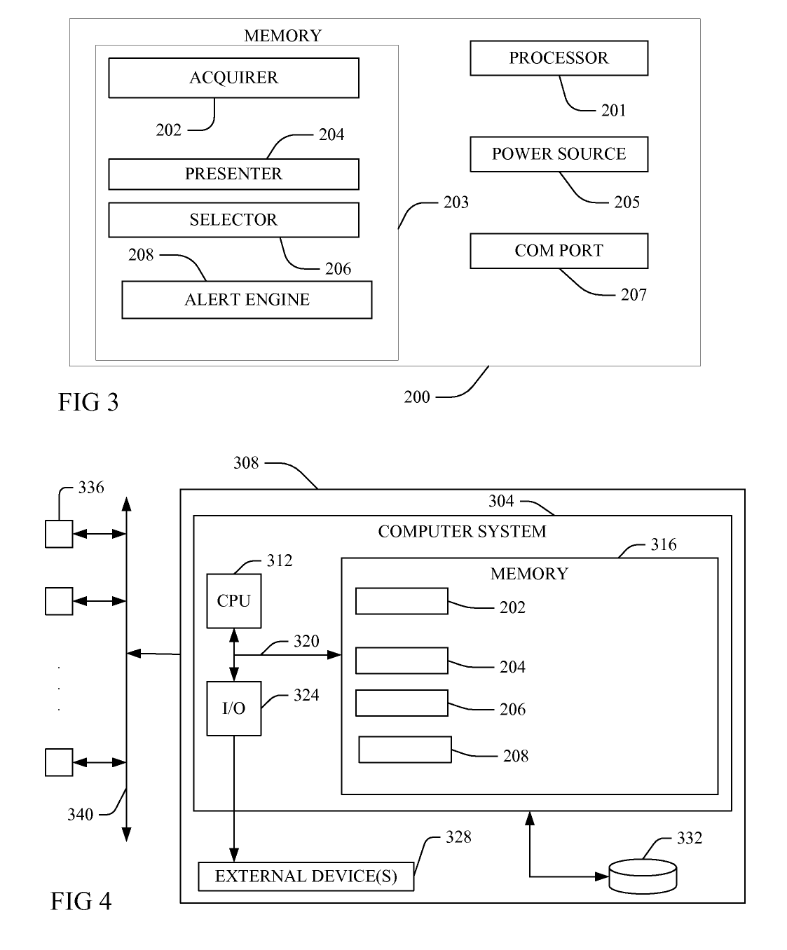

FIG. 3 illustrates a programmable PDA device or module 200 configured to personalized real-time travel information to a passenger of a transit system according to the present invention, for example as illustrated in FIGS. 1-2 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment comprises a central processing unit (CPU) or other processing means 201 in communication with a memory 203 comprising logic components that enable the CPU 201 to perform processes and methods according to the present application, as will be understood through reference to FIGS. 1-2 as discussed above. Thus, the memory 203 comprises a transport data acquirer logic component 202 configured to acquire data through wireless communication with a transport, station, stop or other transit system component, and in some embodiments also incorporating global positioning satellite system (GPS) and radio frequency identification (RFID) components configured to provide real-time transport and station/stop identification and location data to a PDA application; a transport input interface and output/alert presenter logic component 204 configured to present input interfaces and output alerts as a function of passenger/service provider preferences; a transport/destination selector logic component 206 configured to select a transport, route, destination, etc. as a function of passenger and transport data inputs and passenger preferences; and alert engine logic component 208 configured to determine and cause the presentment of alerts and information to the passenger as a function of a passenger preference and passenger and transport data inputs.

A power unit 205 is configured to provide operative power to the device 200; examples include battery units 205 and power inputs configured to receive alternating or direct current electrical power, and other appropriate power units 205 will be apparent to one skilled in the art. A wireless communication port or network link/node means 207 is also provided and configured to enable data and other communications with transport and station nodes as well as with other devices, systems, monitoring, administrative and service provider entities, GPS systems, and RFID components as may be appropriate.

### II. Computerized Implementation

Referring now to FIG. 4, an exemplary computerized implementation of the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage system 332. In general, the processing unit 312 executes computer program code, such as the code to implement various components of the process and systems, and devices as illustrated in FIGS. 1-3 and described above, including the transport data acquirer logic component 202, the presenter logic component 204, the transport/destination selector logic component 206 and the alert engine logic component 208 discussed above, and which are stored in memory 316 and/or storage system 332. It is to be appreciated that two or more, including all, of these components may be implemented as a single component.

While executing computer program code, the processing unit 312 can read and/or write data to/from the memory 316, the storage system 332, and/or the I/O interfaces 324. The bus 320 provides a communication link between each of the components in computer system 304. The external devices 328 can comprise any devices (e.g., keyboard, pointing device, display, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 4 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 1-4 above and described otherwise herein. To this extent, the computer-readable/useable medium includes program code that implements each of the various process steps of the present application.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for providing personalized real-time travel information to a passenger of a transit system, comprising:
a passenger providing a destination input to a programmable personal digital assistant carried by the passenger;
the personal digital assistant establishing a wireless communication with a wireless broadcast system of a transit system and uploading current routing and scheduling information relative to a present geographic location of the personal digital assistant through the wireless communication in response to the destination input;
the personal digital assistant processing the uploaded routing and scheduling information and presenting the processed routing and schedule information to the passenger as a function of the destination input and a passenger preference;
the personal digital assistant selecting and wirelessly locating a transport of the transit system in real-time in response to the destination input, the locating comprising communicating directly with the identified transport through a wireless communication;
the personal digital assistant alerting the passenger of a recommended boarding opportunity of the identified transport in response to wirelessly locating the identified transport relative to a location of the passenger through the wireless communication;
the personal digital assistant recognizing a boarding by the passenger of a transport of the transit system through spatially locating the personal digital assistant within the boarded transport through a wireless communication with the boarded transport;
the personal digital assistant confirming that the boarded transport is the identified recommended transport; and
the personal digital assistant communicating a disembark alert to the passenger in response to either of:
the confirming determining that the boarded transport is not the identified recommended transport and that a change in transport is necessary to reach the destination; and
the personal digital assistant determining an arrival at the destination by the boarded transport;
the communicating the disembark alert comprising configuring and presenting a disembark communication to the passenger as a function of the passenger preference.

2. The method of claim 1, wherein the present geographic location of the programmable personal digital assistant is a transit system station area, further comprising:
the passenger physically entering the transit system station area;
the programmable personal digital assistant carried by the passenger automatically establishing the wireless communication with the wireless broadcast system of the transit system in response to the passenger physically entering the transit system station area; and
the personal digital assistant automatically selecting the presented uploaded routing and scheduling information as a function of a possible service to the station and of the passenger preference.

3. The method of claim 2, further comprising:
the personal digital assistant determining that the passenger failed to disembark the boarded transport at the destination; and
the personal digital assistant recalculating a new routing and destination solution and subsequently communicating a new disembark alert to the passenger.

4. The method of claim 3, wherein at least one of the presenting the processed routing and schedule information to the passenger, the alerting the passenger of the recommended boarding opportunity of the identified transport and the communicating the disembark alert to the passenger comprises at least one of:
translating from a first language supported by the transit system into a second language specified by the passenger preference and not supported by the transit system;
converting audio information into a visual format communication; and
converting visual information into an audio format communication.

5. The method of claim 4, further comprising:
the personal digital assistant wirelessly communicating with the transit system or the boarded transport by communicating without providing personal identification data to the public transit system, the boarded transport, an internet service provider, a cellular phone carrier or a service provider; and
the personal digital assistant storing the personal identification data directly and securely within the personal digital assistant.

6. The method of claim 5, further comprising the personal digital assistant automatically deleting stored personal identification data associated with use of the boarded transport immediately upon the passenger disembarking from the boarded transport.

7. A service for providing personalized real-time travel information to a passenger of a transit system, comprising:
providing a programmable personal digital assistant to a passenger, the programmable personal digital assistant configured to:
receive a destination input from the passenger;
establish a wireless communication with a wireless broadcast system of a transit system and upload current routing and scheduling information relative to a present geographic location of the personal digital assistant through the wireless communication in response to the destination input;
process the uploaded routing and scheduling information and present the processed routing and schedule information to the passenger as a function of the destination input and a passenger preference;
select and wirelessly locate a transport of the transit system in real-time in response to the destination input by communicating directly with the identified transport through a wireless communication;
alert the passenger of a recommended boarding opportunity of the identified transport in response to wirelessly locating the identified transport relative to a location of the passenger through the wireless communication;
recognize a boarding by the passenger of a transport of the transit system through spatially locating the personal digital assistant within the boarded transport through a wireless communication with the boarded transport;
confirm that the boarded transport is the identified recommended transport; and
communicate a disembark alert to the passenger configured and presented as a function of the passenger preference in response to either of:
determining that the boarded transport is not the identified recommended transport and that a change in transport is necessary to reach the destination; and
determining an arrival at the destination by the boarded transport.

8. The service of claim 7, wherein the present geographic location of the programmable personal digital assistant is a transit system station area, the provided programmable personal digital assistant configured to:
automatically establish the wireless communication with the wireless broadcast system of the transit system in response to the passenger physically entering the transit system station area with the programmable personal digital assistant; and
automatically select and upload routing and scheduling information presented through the wireless communication with the wireless broadcast system of the transit system as a function of a possible service to the station and of the passenger preference.

9. The service of claim 8, the provided programmable personal digital assistant configured to:
determine whether the passenger failed to disembark the boarded transport at the destination; and
recalculate a new routing and destination solution and subsequently communicate a new disembark alert to the passenger in response to determining that the passenger failed to disembark the boarded transport at the destination.

10. The service of claim 9, the programmable personal digital assistant configured perform at least one of the presenting the processed routing and schedule information to the passenger, the alerting the passenger of the recommended boarding opportunity of the identified transport and the communicating the disembark alert to the passenger, by at least one of:
translating from a first language supported by the transit system into a second language specified by the passenger preference and not supported by the transit system;
converting audio information into a visual format communication; and
converting visual information into an audio format communication.

11. The service of claim 10, the programmable personal digital assistant configured to wirelessly communicate with the transit system or the boarded transport without providing personal identification data to the public transit system, an internet service provider, a cellular phone carrier or a service provider, and to instead store the personal identification data directly and securely within the personal digital assistant.

12. The service of claim 11, the programmable personal digital assistant configured to automatically delete stored personal identification data associated with use of the boarded transport immediately upon the passenger disembarking from the boarded transport.

13. A method for providing personalized real-time travel information to a passenger of a transit system, comprising:
producing computer executable program code;
storing the code on a computer readable medium; and
providing the program code to be deployed and executed on a programmable personal digital assistant, the program code comprising instructions which, when executed on the programmable personal digital assistant, cause the computer system to:
receive a destination input from a passenger;
establish a wireless communication with a wireless broadcast system of a transit system and upload current routing and scheduling information relative to a present geographic location of the personal digital assistant through the wireless communication in response to the destination input;
process the uploaded routing and scheduling information and present the processed routing and schedule information to the passenger as a function of the destination input and a passenger preference;
select and wirelessly locate a transport of the transit system in real-time in response to the destination input by communicating directly with the identified transport through a wireless communication;
alert the passenger of a recommended boarding opportunity of the identified transport in response to wirelessly locating the identified transport relative to a location of the passenger through the wireless communication;
recognize a boarding by the passenger of a transport of the transit system through spatially locating the personal digital assistant within the boarded transport through a wireless communication with the boarded transport;
confirm that the boarded transport is the identified recommended transport; and
communicate a disembark alert to the passenger configured and presented as a function of the passenger preference in response to either of:
determining that the boarded transport is not the identified recommended transport and that a change in transport is necessary to reach the destination; and
determining an arrival at the destination by the boarded transport.

14. The method of claim 13, the program code comprising instructions which, when executed on the personal digital assistant, causes the personal digital assistant to:
automatically establish the wireless communication with the wireless broadcast system of the transit system in response to the passenger physically entering a transit system station area geographic location with the programmable personal digital assistant; and
automatically select and upload routing and scheduling information presented through the wireless communication with the wireless broadcast system of the transit system as a function of a possible service to the station and of the passenger preference.

15. The method of claim 14, the program code comprising instructions which, when executed on the personal digital assistant, causes the personal digital assistant to:
determine whether the passenger failed to disembark the boarded transport at the destination; and
recalculate a new routing and destination solution and subsequently communicate a new disembark alert to the passenger in response to determining that the passenger failed to disembark the boarded transport at the destination.

16. The method of claim 15, the program code comprising instructions which, when executed on the personal digital assistant, causes the personal digital assistant to perform at least one of the presenting the processed routing and schedule information to the passenger, the alerting the passenger of the recommended boarding opportunity of the identified transport and the communicating the disembark alert to the passenger, by at least one of:
translating from a first language supported by the transit system into a second language specified by the passenger preference and not supported by the transit system;
converting audio information into a visual format communication; and
converting visual information into an audio format communication.

17. The method of claim 16, the program code comprising instructions which, when executed on the personal digital assistant, causes the personal digital assistant to:
wirelessly communicate with the transit system or the boarded transport without providing personal identification data to the public transit system, an internet service provider, a cellular phone carrier or a service provider; and
store the personal identification data directly and securely within the personal digital assistant.

18. The method of claim 17, the program code comprising instructions which, when executed on the personal digital assistant, causes the personal digital assistant to automatically delete stored personal identification data associated with use of the boarded transport immediately upon the passenger disembarking from the boarded transport.

19. A programmable device comprising:
a processing means;
a memory in communication with the processing means comprising a logic component; and
a network interface in communication with the processing means and the memory;
wherein the processing means is configured to:
receive a destination input from a passenger;
establish a wireless communication with a wireless broadcast system of a transit system and upload current routing and scheduling information relative to a present geographic location of the personal digital assistant through the wireless communication in response to the destination input;
process the uploaded routing and scheduling information and present the processed routing and schedule information to the passenger as a function of the destination input and a passenger preference;
select and wirelessly locate a transport of the transit system in real-time in response to the destination input by communicating directly with the identified transport through a wireless communication;
alert the passenger of a recommended boarding opportunity of the identified transport in response to wirelessly locating the identified transport relative to a location of the passenger through the wireless communication;
recognize a boarding by the passenger of a transport of the transit system through spatially locating the personal digital assistant within the boarded transport through a wireless communication with the boarded transport;
confirm that the boarded transport is the identified recommended transport; and
communicate a disembark alert to the passenger configured and presented as a function of the passenger preference in response to either of:
determining that the boarded transport is not the identified recommended transport and that a change in transport is necessary to reach the destination; and
determining an arrival at the destination by the boarded transport.

20. The device of claim 19 wherein the processing means is configured to:
automatically establish the wireless communication with the wireless broadcast system of the transit system in response to the passenger physically entering a transit system station area geographic location with the programmable personal digital assistant; and
automatically select and upload routing and scheduling information presented through the wireless communication with the wireless broadcast system of the transit system as a function of a possible service to the station and of the passenger preference.
